(19) United States
(12) Patent Application Publication
(10) Pub. No.: US 2006/0225662 A1
(43) Pub. Date: Oct. 12, 2006

(54) Enclosure for animals

(76) Inventor: Luiz F. Dias da Silva, Gurnee, IL (US)

Correspondence Address: PGM;Philip G. Meyers Law Office, Suite 300, 1009 Long Prairie Road, Flower Mound, TX, 75022, US

(21) Appl. No.: 11/384,182

(22) Filed: Mar. 17, 2006

Related U.S. Application Data
(60) Provisional application No. 60/663,120, filed on Mar. 18, 2005.

(51) Int. Cl. A01K 63/00; E04F 13/00; B32B 37/00; B32B 37/04; B30B 15/34

(52) U.S. Cl. 119/269; 156/300; 156/297; 156/71; 156/308.4; 156/583.1; 156/579

(57) ABSTRACT

Enclosures for animals, including cages, kennels, and aquariums are provided wherein at least one side wall of the enclosure is lined along at least a portion thereof that is regularly exposed to animal wastes or other contaminants with a protective polymeric film having a layer of adhesive secured to one side thereof, which adhesive secures the film to the side wall. In a preferred from, the polymeric film comprises a fluoropolymer, each side wall has a smooth, solid inner surface to which sheets of the protective film are adhered side by side, and a lower portion of the inner surface of each side wall is covered in a manner that provides continuous coverage from one side wall to an adjacent side wall, i.e. around the periphery of a rectangular enclosure. The protective film makes it easier to clean animal wastes and other contaminants from the enclosure.

### RELATED APPLICATION

This application claims priority of U.S. Provisional Application Ser. No. 60/663,120, filed Mar. 18, 2005.

### BACKGROUND OF THE INVENTION

Dias da Silva U.S. Pat. No. 5,769,019, issued Jun. 23, 1998, describes a method of protecting an outdoor structure such as the hull of a marine craft from adhesion of marine growths and inorganic deposits by applying protective flexible covering sheets to the hull. The sheets are preferably applied in a pattern that provides substantially complete coverage of at least the portion of the external surface that is submerged during normal use of the marine craft. The sheets have an outer surface consisting essentially of a polymer such as PTFE that resists adhesion of marine growths and inorganic deposits, and an inner surface comprising a water-resistant adhesive effective to secure the sheets to the outer hull surface and prevent the sheets from coming off during normal use.

Due to the difficulty of providing an adhesive directly to a PTFE sheet, the '019 patent used a trilaminate sheet comprising a smooth, non-porous, outer layer of Teflon or a comparable polymeric material, an intermediate plastic layer, and an adhesive layer on the side of the intermediate layer opposite the PTFE layer. Since that time, a variety of bi-layered PTFE film products have become available wherein the adhesive is applied directly to one surface of a PTFE, which surface has been etched or roughened to promote such adhesion. Such products are preferred for use in the invention, as further described below.

The '019 patent describes applying the polymer film sheets in a pattern resembling fish scales, such that each sheet overlaps an edge portion of another sheet. In practice it has been found that this arrangement over time is prone to coming loose, causing the sheets to peel and allowing water to leak in. The present invention provides an improved method for application of such films wherein the seams or joints between sheets are less subject to deterioration, as well as a tool for carrying out a seam sealing operation.

The invention relates further to applications for such films in indoor environments and other structures not suggested in da Silva U.S. Pat. No. 5,769,019 in order to reduce time and effort expended in certain cleaning and sanitizing jobs. Accumulated animal waste on inside surfaces of kennels and cages used to house pets such as dogs, cats, hamsters and birds presents a difficult and time consuming cleaning task. Similarly, the job of cleaning blood and other fluids from surfaces in an operating room or emergency room of a hospital can be difficult, depending upon the porosity and other physical properties of the underlying material. Removing mineral deposits, such as calcium and magnesium carbonates, and algae buildup from the inside walls of an aquarium is another time consuming chore, typically requiring scrubbing of the surfaces. The present invention addresses these needs.

### SUMMARY OF THE INVENTION

A method is provided according to the invention for applying a series of protective covering sheets to a surface wherein each sheet comprises a protective polymeric film having a layer of adhesive secured to one side thereof. Such a method includes the steps of applying a first protective covering sheet to the surface, then applying a second protective covering sheet to the surface such that an edge portion of the second sheet overlaps an edge portion of the first sheet, and then bonding the overlapped edges to one another by application of heat. The surface will typically be an external surface of a structure such as a watercraft, a land vehicle such as an automobile, truck, bus or RV, or a military, private or commercial aircraft, or an indoor surface as described further below.

The invention further provides a rotary tool useful for bonding edge portions in the foregoing method using heat. Such a tool comprises a heating device such as a soldering iron with a tip that includes a rotary element, e.g., a roller mounted on an axle, or a metal ball mounted in a socket. The rotary element receives heat conducted from the heating element in the soldering iron. The user presses the heated rotary element against the overlapped edges and draws it along the edges, applying heat and pressure sufficient to create a fused seam as described hereafter. The tool according to the invention could be hand held (used manually) or be provided as a fixture at the end of a robotic arm having a controller that operates the arm to carry out the method of the invention.

The foregoing method seeks to create a seal between two layers of fluoropolymer film such that seam failure due to the lifting of the upper layer is eliminated. The application of the heated wheel with moderate pressure over a seam consisting of overlapping fluoropolymer film layers causes the two layers to partially or completely melt and fuse.

The invention further provides a method of reducing the adherence of a waste material to a surface, comprising applying a film sheet to the surface, the film sheet comprising a outer, fluoropolymer film and an adhesive in contact with the film and surface, wherein the surface is part of a structure that is regularly exposed to human or animal wastes or bodily fluids which accumulate on the surface and require removal. Applying self-adhesive fluoropolymer films to such surfaces can substantially reduce the time, energy and effort required to clean the surfaces.

The invention further relates to specific types of enclosures for animals, including cages, kennels, and aquariums, wherein at least one side wall of the enclosure is lined along at least a portion thereof that is regularly exposed to animal wastes or other contaminants with a protective polymeric film having a layer of adhesive secured to one side thereof, which adhesive secures the film to the side wall. In a preferred form, the polymeric film comprises a fluoropolymer, each side wall has a smooth, solid inner surface to which sheets of the protective film are adhered side by side, and a lower portion of the inner surface of each side wall is covered in a manner that provides continuous coverage from one side wall to an adjacent side wall, i.e. around the periphery of a rectangular enclosure. In the case of an aquarium, other contaminants would include marine plant growths. These and other aspects of the invention are described further in the detailed description that follows.

### BRIEF DESCRIPTION OF THE DRAWING

The invention will be described with reference to the accompanying drawing, wherein like numerals denote like elements, and:

FIG. 1 is a side view of an assembled heat-sealing tool according to the invention;

FIG. 2 is a side view of the heat sealing tool of FIG. 1 with the roller tip disassembled;

FIG. 3 is a cross section through the roller shown in FIGS. 1 and 2;

FIG. 4 is a cross section of an edge sealing operation according to the invention;

FIG. 5 is a perspective view of an animal cage or kennel partially lined according to the invention;

FIG. 6 is a top view of the cage of FIG. 5.

FIG. 7 is a perspective view of an aquarium wherein the inside surfaces of three walls have been lined according to the invention;

FIG. 8 is a top view of the aquarium of FIG. 7;

FIG. 9 is a side view of an operating table in an operating room wherein portions of the surface of the table and walls of the room have been lined according to the invention; and

FIG. 10 is an end view of the operating table of FIG. 9.

### DETAILED DESCRIPTION OF PREFERRED EMBODIMENTS

A method for the bonding of the upper film layer to the bottom film layer is required for the optimum performance of the film coating process. Due to the non-reactive properties of fluoropolymer films, this method must include the application of heat. Alternate methods of bonding have been tried with limited success, such as the use of adhesive “primers” or enhancers to create an acceptable attachment between the upper and lower film layers. This method still did not provide a permanent bond. Another approach incorporated the use of a directed “hot air” flow over the overlap of the film layers. This method was not successful because the heat could not be precisely directed or controlled and in many instances caused damage to an underlying fiberglass substrate.

The preferred method involves direct surface-to-surface heat transfer. A preliminary attempt to apply this method involved the use of a soldering iron pressed over the overlapping edges of the two film layers. This proved successful but left an uneven and unsightly “scar” over the film layers. This is of concern because the rough “scar” surface could affect the laminar flow of water and hence reduce the efficiency of the fluoropolymer surface to reduce drag, in addition to worsening the appearance of the films.

The preferred method of heat application according to the invention incorporates a high power soldering iron with a specially built rotating wheel tip. The heat sealer is intended for use in the sealing of fluoropolymer film seams on watercraft, land vehicles and aircraft, although it be used on any surface with sufficient strength and heat resistance. The device in the example below consists of a commercially available 150 watt soldering iron (“American Beauty” from HMC Electronics, ⅜″ tip opening) fitted with a metal wheel tip assembly especially designed to operate at temperatures in excess of 700° F.

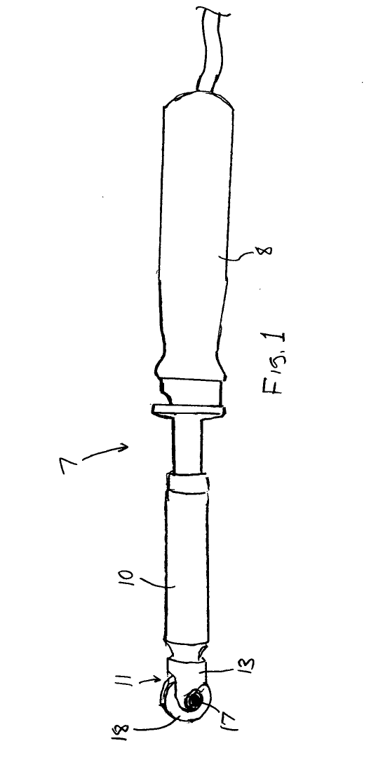

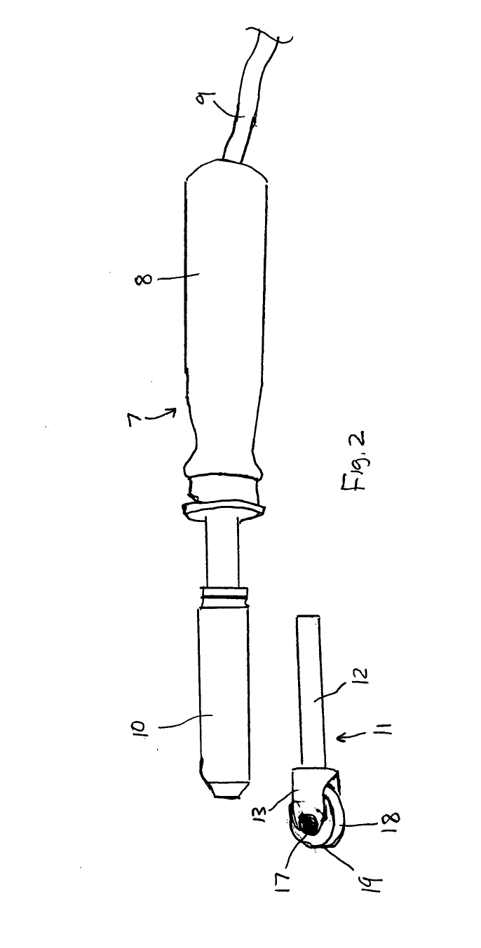

Referring to FIGS. 1-3, a rotary heating device 7 includes a heat resistant handle 8 with an internal electric heating element that becomes heated by means of an AC electric current supplied through an electrical cord 9. An adjustable chuck 10 holds a removable tip 11 securely during use. Removable tip 11 comprises a shank 12 ending in a clevis 13 of enlarged diameter. Shank 12 is fully inserted into chuck 10 as shown in FIG. 1, leaving a rear surface of clevis 13 in engagement with the front of chuck 10. Clevis 13 supports a pin or axle 17. In the embodiment shown, the ends of pin 17 have been welded to prevent removal of pin 17 from the corresponding holes in clevis 13, but a pin with a head at one end and a transverse hole at the other secured by a cotter pin could also be employed.

A roller 18 having a cylindrical circumferential surface 19 is rotatably mounted on pin 17 by means of a high temperature bearing 16. The width of roller 18 and its roller surface 19 are determined according to the desired width of the seam between adjacent plastic films. Roller 18 is preferably made of aluminum (or other suitable heat conducting metal). It is approximately 1″ in diameter and rotates on high temperature steel bearing 16 lubricated with high temperature grease. Alternatively, a ceramic bearing may be used. Shank 12 and clevis 13 are likewise preferably made of aluminum so that heat may be conducted to roller 18 with high efficiency.

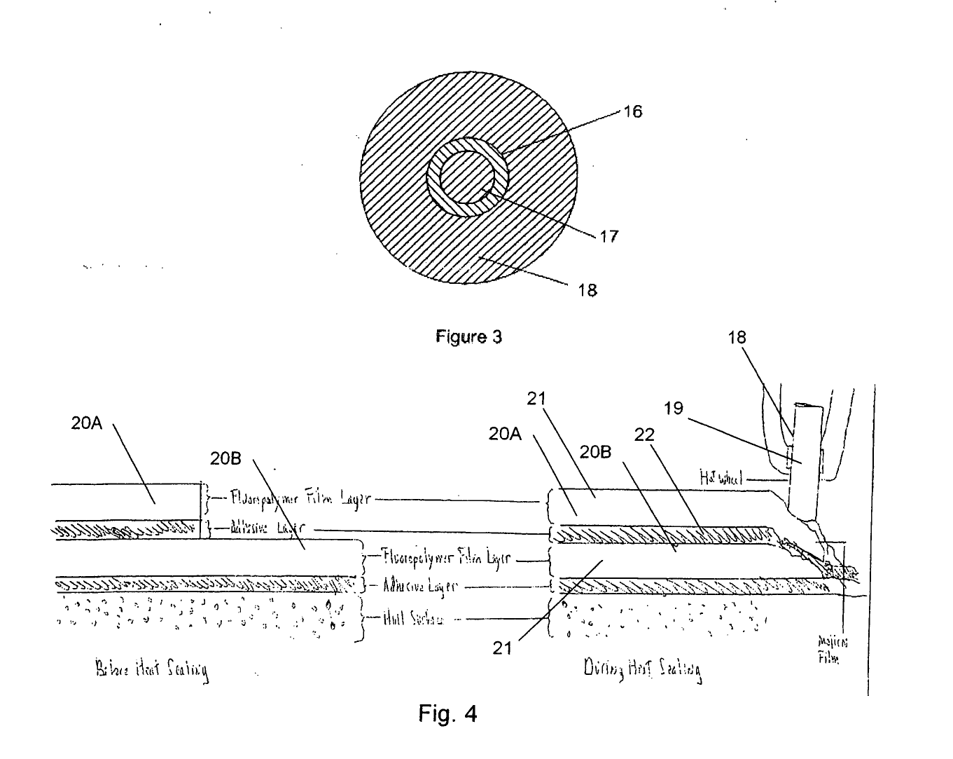

In use, the device is heated and manually rolled over the slightly overlapping edges of the fluoropolymer film placed on the surface of the structure to be protected, such as the outside of a boat hull. Referring to FIG. 4, each film sheet 20A, 20B comprises a fluoropolymer film layer 21 and an adhesive layer 22. Roller 18 presses the superposed edges of sheets 20A, 20B togther and heats them sufficiently to fuse the sheets 20A, 20B together. For this purpose the speed at which roller 18 is moved along the seam should permit such fusing to occur without melting the sheets entirely. The temperature of the surface 19 of roller 18 is preferably in the range of about 650-900° F., most preferably from 700-900° F. when working with PTFE sheets. The pressure needed to produce a satisfactory surface melt is moderate (e.g., 1-2 lbs). The roller speed will vary according to the initial surface temperature of the PTFE films. If the films are on a hot hull (exposed to the sun on a hot day), the speed may be as fast as 2″/sec. The heat sealing application process may include two or more passes of the roller 18 over the same area to assure a complete seal.

For purposes of the invention, the extent of sheet overlap should be at least 0.1″, preferably in the range from 0.2″ to 0.3″ inch. The optimum overlap appears to be approximately 0.25″. The film sheets used in trials of the method of the invention were 12″ by 24″, but larger or smaller sheets could be used. Film sheet thickness is preferably from about 3 to 20 mils. Film thicknesses below 3 mils become very difficult to handle (i.e., like kitchen wrap). Thicknesses in excess of 20 mils become too stiff to be practical when applied as an adhesive film.

Preferred films for use in the invention include FEP, ETFE, PTFE polymeric films having, a layer of a water-resistant adhesive such as acrylic, silicone, etc., bonded to a specially prepared surface of the fluoropolymer film to achieve an acceptable peel strength. Such a surface treatment may consist of but not be limited to plasma or chemical etching. The use of this film on watercraft can provide fuel savings of approximately 5-12%, with a proportional increase in speed, and represents an environmentally safe alternative to the currently used Cu and Sn ablative paints due to the extremely low toxicity of fluoropolymer films and adhesive system being used.

According to a preferred embodiment, the sheets comprise a laminate of an outer layer consisting essentially of a polyhalocarbon composed of units of the formula (-CX₂-CX₂)ₙ-), wherein X is selected from the group consisting of hydrogen, a halogen or a halogen-substituted side chain, provided that at least one X is not hydrogen, an inner layer comprising the water-resistant adhesive and a protective release liner incorporating micro-channel technology such that the micro-channels are impressed into the adhesive surface thus allowing for the bleeding of trapped air to exit the space between the adhesive and the surface of the object being covered, such as “Comply” liner sheets made by 3M Corporation. This film is laminated to an acrylic or other suitable water proof adhesive layer. The method can also be used with trilaminate films as described in U.S. Pat. No. 5,769,019, provided that the thicknesses allow for sufficient heat transfer to the underlying layers. A bilaminate film as described above is preferred because heat transfers quickly, expediting the sealing process.

Application of film sheets according to the invention requires special cutting of the film to achieve acceptable fit in areas of specific shapes, such as a keel. Seams between sheets normally run vertically as the product is applied from back to front. However, when patches are needed, the seams may be in any direction. The orientation of the seams is not critical to the success of the method. The configuration may resemble that shown in the drawings of U.S. Pat. No. 5,769,019, except that there is no need to render the underlying layer jagged as shown therein.

The method of the invention could be used in butt-welding situations, that is, where the edges of adjacent sheets are in contact with no sheet overlap, but such use is less likely to produce a suitable seam and is not preferred. However, according to another aspect of the invention, where two such sheets meet edge to edge, a third sheet or narrow film strip may be applied over the edges and the sealed to both underlying sheets using the method of the invention.

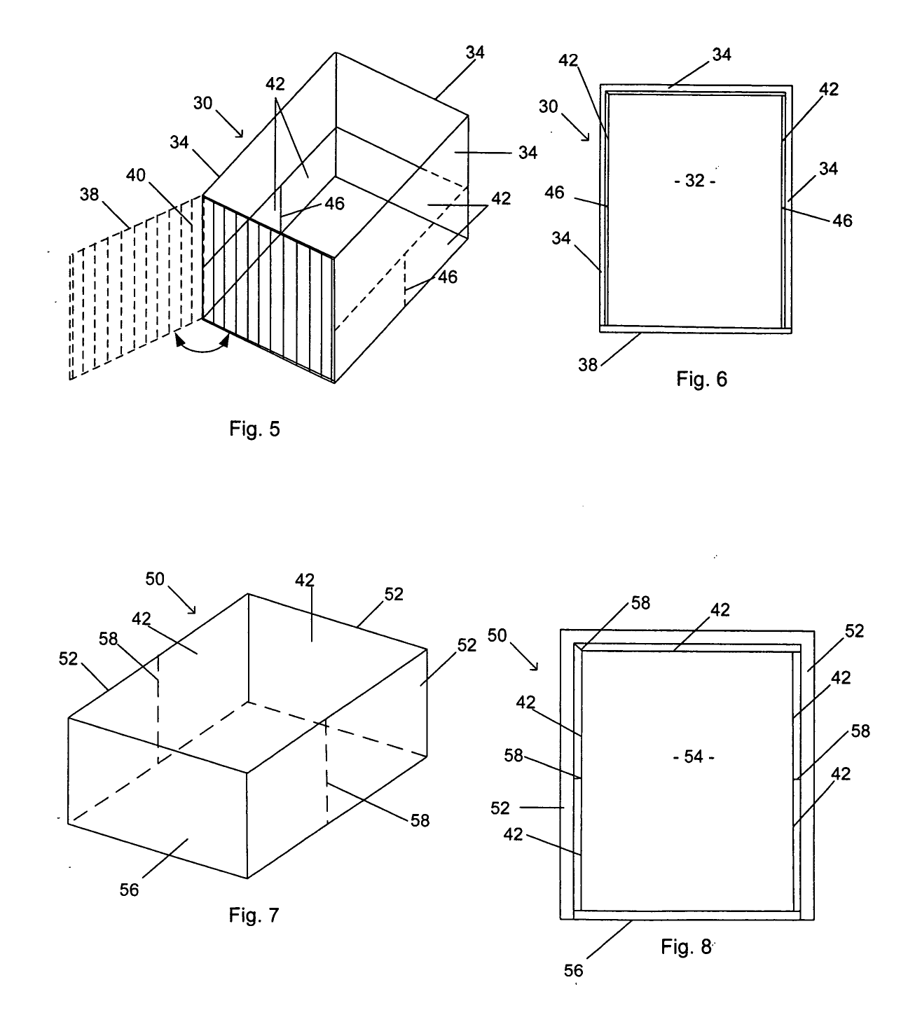

Referring to FIGS. 5 and 6, a cage or kennel 30 according to the invention includes a floor 32, side walls 34, a top (omitted in this view) and a door 38 formed from a series of bars 40. In accordance with the invention, side walls 34 are solid, smooth-surfaced walls (as opposed to chain link fence material, for example) that have been lined with fluoropolymer film sheets 42. As illustrated, each of film sheets 42 abuts or overlaps an adjoining film sheet 42 at a seam 46. Each of film sheets 42 comprise a bilaminate sheet including a fluoropolymer film layer and an adhesive layer or a trilaminate sheet that includes a protective release liner in addition to the fluoropolymer film and adhesive. Typically, film sheets 42 will be between 2-5 mils in thickness and do not require joining at seam 46, although this may be done to obtain complete coverage.

Depending upon the type of animal(s) held in cage 30, it may be desirable to entirely line walls 34, 36 with film sheets 42 or, alternatively, line the walls to the height where animal wastes come in contact with the walls, as shown. Thus, in one preferred embodiment, at least one of walls 34, 36 of cage 30 is lined with film sheet 42 to at least the height at which contact with animal waste is expected. Normally, the floor 32 of cage 30 will not be lined since the slick surface of the fluoropolymer film would cause the animal difficulty when walking in cage 30. However, where floor 32 comprises a grate with a collection tray beneath the grate, the collection tray is preferably lined with a film according to the invention to prevent animal waste from adhering to the tray.

Film sheets 42 have the advantage of being retrofittable to any clean, dry cage surface whether it be the walls, door, ceiling or a collection tray beneath the floor of cage 30. Animal waste contacting an inside wall of cage 30 lined with a film sheet 42 will not adhere to the surface to the degree that such waste will adhere to a bare or painted surface. Preventing animal waste from adhering to the inside surfaces of cage 30 greatly reduces the amount of time and effort required to clean the cage. This reduction of time and energy will be particularly useful to researchers, veterinarians, pet stores, animal breeders, kennels and other entities that house large numbers of animals in cages. This embodiment applies both to portable cages and permanent cage structures.

Referring to FIGS. 7 and 8, in another embodiment, a aquarium or fish tank 50 of the type commonly used in museums has opaque side walls 52, a floor 54 which may be covered with decorative stones or other filler, and a transparent glass front wall 56. The opaque wall(s) 52 (which could comprise a single curving wall) are lined with film sheets 42, along with floor 54 and ceiling if present, to reduce the amount of effort required to clean mineral deposition and algae growth from the aquarium. In this application, sealing of seams 58 of film sheets 42 is needed. If front wall 56 is also lined with a sheet 42, the sheet should be sufficiently transparent to permit viewing of aquatic life forms housed in aquarium 50. In the case where aquarium 50 is merely a holding tank and viewing is not a consideration, sheets 42 may be translucent or opaque.

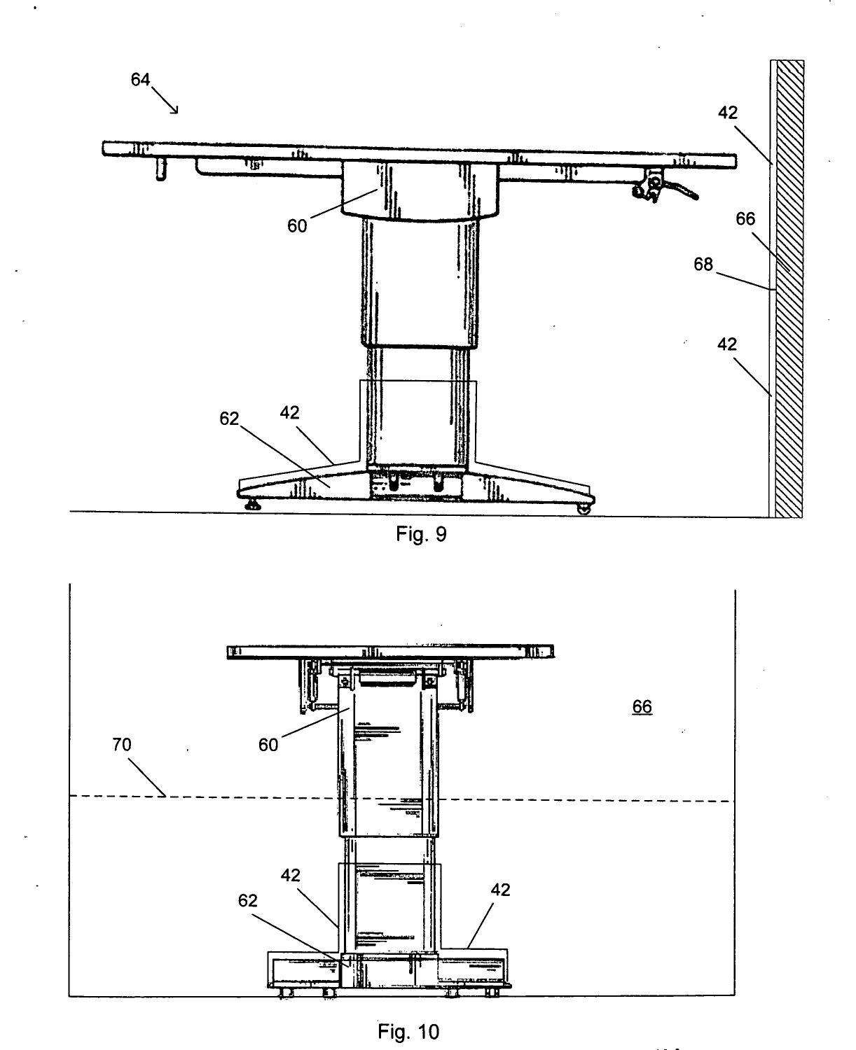

Turning to FIGS. 9 and 10, film sheets 42 are utilized to prevent blood, other fluids and waste materials from adhering to selected surfaces in an operating room environment. As illustrated, the base 62 of operating table 60 is wrapped or covered with film sheets 42, as are at least lower portions of walls 66 of operating room 64, for example, with an upper edge 70 at least 3 feet from the floor. Preferably, in medical applications, seams 68 of film sheets 42 are sealed as described above. Covering wrapping and/or lining the surfaces of other medical appliances and fixtures may also be desirable. The use of sheets 42 in these applications reduces the amount of labor and time expended by medical personnel such as nurses, nurses aids and orderlies in cleaning and sanitizing. Making such surfaces easier to clean also results in more sanitary conditions for patients and medical personnel.

It will be understood that the foregoing description is of preferred exemplary embodiments of the invention, and that the invention is not limited to the specific forms shown. Modifications may be made in without departing from the scope of the invention as expressed in the appended claims.

1. A method for applying a series of protective covering sheets to a surface, wherein each covering sheet comprises a protective polymeric film having a layer of adhesive secured to one side thereof, comprising:
applying a first covering sheet to the surface so that the adhesive layer of the first sheet adheres to the surface;
applying a second protective covering sheet to the surface so that the adhesive layer of the second sheet adheres to the surface and an edge portion of the second sheet overlaps an edge portion of the first sheet; and
then bonding the overlapped edges to one another by application of heat.

2. The method of claim 1, wherein the polymeric film comprises a fluoropolymer.

3. The method of claim 2, wherein the polymeric film consists essentially of PTFE.

4. The method of claim 1, wherein the bonding step comprises rolling a heated rotary element over the overlapped edges.

5. The method of claim 1, wherein the polymeric film comprises a fluoropolymer, and the bonding step comprises rolling a heated rotary element over the overlapped edges, wherein the head is heated to a temperature sufficient to melt and fuse the overlapped edges.

6. The method of claim 5, wherein the structure is an outdoor structure.

7. The method of claim 5, wherein the structure is an indoor structure.

8. The method of claim 5, wherein the structure is a motorized vehicle, and the sheets are applied to cover at least a portion of a surface the vehicle in a manner effective to reduce fuel consumption of the vehicle.

9. A rotary tool useful for bonding edge portions of overlapping protective sheets, comprising a heating element and a tip at a distal end of the tool that includes a rotary element that receives heat conducted through the tip from the heating element

10. The tool of claim 9, further comprising a handle located at a proximal end of the tool whereby the rotary tool can be applied manually to edge portions of overlapping sheets.

11. The tool of claim 9, further comprising a chuck whereby the tip can be removably secured to the heating element.

12. The tool of claim 11, wherein the tip comprises a shank configured to fit in the chuck, a clevis at one end of the shank mounting an axle, and a roller rotatably mounted on the axle.

13. An enclosure for animals including one or more side walls and a floor, improved in that at least one side wall the enclosure is lined along at least a portion thereof that is regularly exposed to animal wastes with a protective polymeric film having a layer of adhesive secured to one side thereof, which adhesive secures the film to the side wall.

14. The enclosure of claim 13, wherein the enclosure comprises a cage or kennel.

15. The enclosure of claim 13, wherein the enclosure comprises an aquarium.

16. The enclosure of claim 13, wherein the side wall has a smooth, solid inner surface to which sheets of the protective film are adhered side by side.

17. The enclosure of claim 16, wherein adjacent edges of side by side sheets of the protective film are heat-bonded together.

18. The enclosure of claim 13, wherein the polymeric film comprises a fluoropolymer.

19. The enclosure of claim 18, wherein the polymeric film consists essentially of PTFE.

20. The enclosure of claim 13, wherein the polymeric film comprises a fluoropolymer, each side wall has a smooth, solid inner surface to which sheets of the protective film are adhered side by side, and at least a lower portion of the inner surface of each side wall is covered in a manner that provides continuous coverage from wall to wall.
